(19) United States
(12) Patent Application Publication
(10) Pub. No.: US 2002/0113745 A1
(43) Pub. Date: Aug. 22, 2002

(54) Scalar quad ridged horn

(76) Inventor: Peter C. Strickland, Ottawa (CA)

Correspondence Address: Shapiro Cohen, Station D, P.O. Box 3440, Ottawa, ON, K1P 6P1, CA

(21) Appl. No.: 10/079,897

(22) Filed: Feb. 22, 2002

Related U.S. Application Data
(60) Provisional application No. 60/270,194, filed on Feb. 22, 2001.

(51) Int. Cl. H01Q 13/00

(52) U.S. Cl. 343/786; 343/772

(57) ABSTRACT

Quad ridged horn antennas which may be individually disposed at the focal point of a parabolic reflector, or in an antenna array of parabolic reflectors. In the field of satellite communications, focus-fed parabolic reflectors are required to be compact yet provide broadband signal services. As such, the antenna horn feed structure must be very compact and provide equally broadband services. In order to provide uniform excitation of a parabolic reflector antenna, the antenna must have equal beamwidths in the E plane and the H plane. The quad ridged horn antenna of the invention equalizes these beamwidths through of a conductive ring around the mouth of the horn antenna. Matching the E plane and the H plane beam widths results in uniform excitation of a parabolic reflector. The conductive ring is advantageously effective for exciting a reflector or an array of reflectors in two closely spaced bands, such as the Ku band.

This application relates to U.S. Provisional Patent Application 60/270,194 filed Feb. 22, 2001.

### FIELD OF INVENTION

This invention relates to ridged horns utilized in satellite communications. More particularly, this invention relates to a ridged horn having a conductive ring to provide E plane and H plane beamwidth equalization for a dual-band antenna system.

### BACKGROUND TO THE INVENTION

In the field of satellite communications, antenna systems are required to have a broad bandwidth while having a narrow antenna beam width. The broad bandwidth enables the antenna system to both transmit and receive signals over frequency bands of several GHz. The narrow antenna beam width provides a high gain for signals that are received and transmitted over a particular frequency to and from a particular satellite, and provides discrimination between satellites.

Transmission and reception of data on aircraft via FSS (Fixed Satellite Service) satellites requires antennas having very broad bandwidth and narrow azimuth beamwidth. The broad bandwidth is required to accommodate a 12.2 to 12.7 GHz receive band along with a 14.0 to 14.5 GHz transmit band. In addition some installations must be able to receive DBS satellite broadcasts over the 10.7 through 12.75 GHz band. Data rates over the FSS satellites are expected to be several MBPS. The antenna feed structure required to support these services must be very broadband. The antenna itself must be very compact and also equally broadband. The focus-fed paraboloid is a candidate for such antennas and if the paraboloid is very compact then the feed must also be very tiny to avoid excessive aperture blockage and excessive swept volume. The quad-ridged waveguide horn is an attractive choice for such systems.

Conventional quad-ridged horns have a much broader beamwidth in the H plane than the E plane. The E plane is defined as the plane that contains the far field electric vector and the horn axis. The H plane is defined as the plane that contains the far field magnetic field vector and the horn axis. In order to efficiently excite a parabolic reflector system it is necessary to have near equal beamwidths in the E plane and the H plane. A horn with equal E plane and H plane beamwidths is described as being scalar.

In the prior art, U.S. Pat. No. 5,905,474, issued to Ngai et al., discloses a microwave antenna feed structure which utilizes a feed spoiler in order to reduce the antenna sidelobe levels. Ngai teaches feed spoilers which are electrically conductive and form a roof with two faces. Both faces have edges which are coupled electrically to the waveguide of the feed structure. Ngai also teaches the use of two feed spoilers which are coupled electrically to the waveguide, thus forming a continuous spoiler around the waveguide. Although a conductive ring around the waveguide of the horn feed is taught by Ngai, a beam width equalization through use of a conductive ring is not taught. Furthermore, the Ngai patent does not teach the uniform excitation of a horn fed parabolic reflector.

U.S. Pat. No. 6,208,310, issued to Suleiman et al., discloses an antenna feed horn having multiple chokes. The chokes are defined as annular notches having both radial and axial dimensions. The chokes disclosed are located at the mouth of the horn antenna and Suleiman discloses the use of other chokes located proximate to the mouth portion. These chokes alter the mode content of the signal transmitted by the horn such that the E plane and the H plane beam widths are substantially equal. However, Suleiman does not teach the possibility that these chokes would provide uniform excitation of a horn fed parabolic reflector. Furthermore, the Suleiman patent does not teach their use with a dual-ridged or a quad-ridged horn antenna. Moreover, Suleiman does not disclose a conductive ring connected electrically to a ridged horn through use of a conductive connection, such that a gap between the conductive ring and the ridged horn produces equal E plane and H plane beam widths.

In order to overcome the aforementioned shortcomings, the present invention seeks to provide a ridged horn antenna having a conductive ring at mouth of the horn antenna optimized to provide E plane and H plane beamwidths equalized in a dual-band operation. The conductive ring would also have a ring depth which is optimized for simultaneous operation in the receive band and the transmit band. The present invention further seeks to provide the uniform excitation of a horn fed parabolic reflector for a dual-band antenna system.

### SUMMARY OF THE INVENTION

The present invention relates to quad ridged horn antennas which may be individually disposed at the focal point of a parabolic reflector, or in an antenna array of parabolic reflectors. In the field of satellite communications, focus-fed parabolic reflectors are required to be compact yet provide broadband signal services. As such, the antenna horn feed structure must be very compact and provide equally broadband services. In order to provide uniform excitation of a parabolic reflector antenna, the antenna must have equal beamwidths in the E plane and the H plane. The quad ridged horn antenna of the invention equalizes these beamwidths through of a conductive ring around the mouth of the horn antenna. Matching the E plane and the H plane beam widths results in uniform excitation of a parabolic reflector. The conductive ring described here is advantageously effective for exciting a reflector or an array of reflectors in two closely spaced bands, such as the Ku band.

According to the present invention, a quad-ridged horn antenna or a dual-ridged horn antenna may be utilized. The conductive ring attached around the horn mouth may be a square, a rectangle, or a circular cross-section. There is a conductive connection between the conductive ring and the ridged horn. The connection and ring block induced currents created between the conductive ring and the ridged horn. The depth of the conductive ring is adjusted, along with the width of the conductive connection, to provide a desired impedance at the mouth of the ridged horn antenna. In a preferred embodiment, the conductive ring has a depth of less than half of one free space wavelength in each of the two operating bands.

In one aspect, the present invention provides a ridged horn antenna for transmitting and receiving signals in dual-bands and having equal E plane and H plane beamwidths, the ridged horn antenna including:

an excitation means;

a horn waveguide, being an electrically conductive conduit, and the horn waveguide having a first end and a second opposite end along a horn axis, the first end adjacent to the excitation means, and the horn waveguide forming a mouth at a second opposite end;

four ridges being spaced apart and extending longitudinally on an inner side of the horn waveguide relative to horn axis and each of the four ridges tapering to the mouth of the horn waveguide, the four ridges having a 180 degree rotational symmetry, and the four ridges being excited by the excitation means at a first end of the horn waveguide; and

a conductive ring around the mouth of the horn for terminating an aperture field formed between each of the four ridges, the conductive ring having a ring depth being optimized for simultaneous operation in a receive band and a transmit band of the dual-band;

wherein the E plane and H plane beamwidths are equalized.

### BRIEF DESCRIPTION OF THE DRAWINGS

The present invention will now be described with reference to the accompanying drawings, in which:

FIG. 1 is a frontal view of a ridged horn antenna and its excitation conductors according to the prior art;

FIG. 2 is a sectional side view of the ridged horn antenna of FIG. 1 according the prior art;

FIG. 3 is a rear view of a ridged horn antenna having a square conductive ring about the mouth of the horn antenna according to a first embodiment of the present invention;

FIG. 4 is a sectional side view of the ridged horn antenna illustrating the ring depth and conductive connection between the horn waveguide and the conductive ring according to a first embodiment of the present invention;

FIG. 5 is a rear view of a ridged horn antenna having a conductive ring with a rectangular cross-section according to a second embodiment of the present invention;

FIG. 6 is a rear view of a ridged horn antenna having a conductive ring with a circular cross-section according to a third embodiment of the present invention; and

FIG. 7 is a side view of a plurality of ridged horn feed antennas each located at the focal point of a corresponding parabolic reflector in a contiguously disposed array of parabolic reflectors.

### DETAILED DESCRIPTION

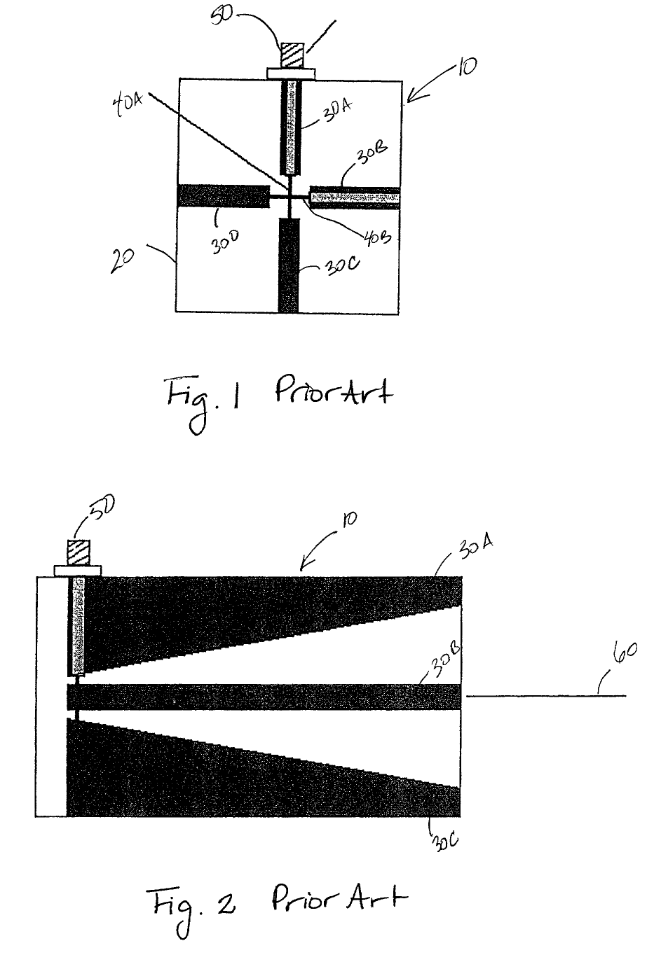

FIG. 1 illustrates a frontal view of a quad-ridged horn antenna 10 according to the prior art. The term front or frontal refers to the end of the horn facing away from a parabolic reflector. The outside surface of the horn antenna 10 is an electrically conductive conduit, hereinafter a horn waveguide 20. The horn antenna 10 further comprises four ridges 30A, 30B, 30C, 30D and two excitation conductors 40A, 40B. Each excitation conductor is connected to two of the four ridges 30A, 30B, 30C, 30D. The excitation conductors 40A, 40B excite the field between the four ridges which radiates from the antenna horn 10. An input/output connector 50 is in turn connected to both excitation conductors 40A, 40B to provide an input means and an output means to the excitation conductors 40A, 40B. Typically, a dual-ridged horn antenna will have one excitation conductor while a quad ridged horn antenna will have two excitation conductors.

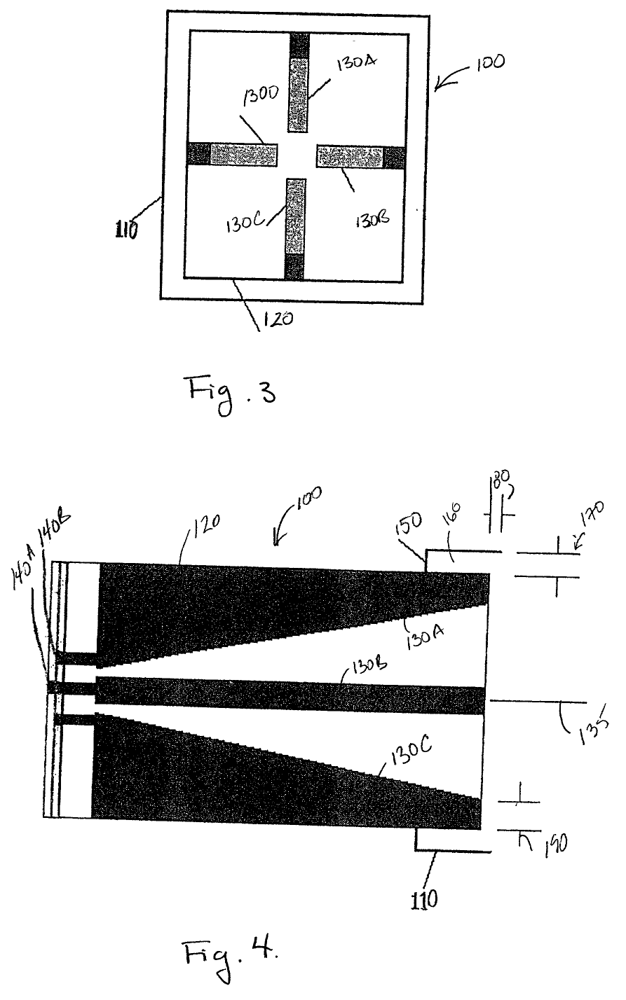

FIG. 2 further illustrates a sectional side view of the quad-ridged horn antenna 10 of the prior art. Both ridges 30A and 30C are shown, as well as ridge 30B, in this cross-sectional view of the quad-ridged horn antenna 10. As shown in FIG. 2, all four ridges 30A, 30B, 30C, 30D are spaced apart and extend longitudinally on an inner side of the horn waveguide relative to horn axis 60. Each of the four ridges 30 taper to the mouth of the horn waveguide. FIG. 2 illustrates the tapering of the ridges 30A and 30C. It should be mentioned that the four ridges 30A, 30B, 30C, 30D are positioned such that the horn antenna 10 has 90 degree rotational symmetry.

The fields created by the ridges 30A, 30B, 30C, 30D originate from the back of the horn antenna 10. The electric field is concentrated between opposing ridges 30A and 30C, or 30B and 30D, and consequently are very uniform across the horn antenna 10 in the E plane and highly peaked in the H plane. As a result, the E plane beamwidth is narrow and the H plane beamwidth is broad.

The present invention will now be described with use of FIG. 3 and FIG. 4 in which a scalar quad-ridged horn antenna 100 is illustrated. FIG. 3 illustrates a conductive ring 110 which surrounds the mouth of the horn antenna 10 and extends beyond the horn waveguide 120. The horn antenna 100 also comprises four ridges 130A, 130B, 130C, 130D which are spaced apart and extend longitudinally along the horn waveguide 120. The horn waveguide 120 minimizes the radiation outside the main beam of the radiating ridges and provides a mechanical means for supporting the four ridges 130A, 130B, 130C, 130D. In FIG. 3, the dark shading of each of the four ridges 130A, 130B, 130C, 130D represents the tapering of the ridges to the mouth of the horn antenna. As FIG. 3 is a rear view of the horn antenna 100 that is the mouth facing the parabolic reflector—a cross-section of the horn antenna 100 at the mouth of the horn antenna 100—then the light shading of the four ridges 130A, 130B, 130C, 130D represents the portion of the four ridges 130A, 130B, 130C, 130D which extends longitudinally from the mouth of the horn antenna 100 relative to the horn axis 135.

In FIG. 4, the two excitation networks 140A and 140B are shown as connected to their corresponding ridges in order to excite the field between the four ridges 130A, 130B, 130C, 130D. The field created radiates from the horn antenna 100. The conductive ring 110 is connected to the horn waveguide 120 at a point furthest from the horn aperture. A conductive connection 150 provides an optimal termination to the aperture fields which are formed between the conductive ring 110 and the horn waveguide 120. The gap 160, between the conductive ring 110 and the horn waveguide 120, has a depth dimension 170 which may be optimized to produce the desired E and H plane beamwidths. The ring depth 170 is less than one half of one free space wavelength at each of the operating frequencies of the horn antenna 100. The optimized ring depth 170 minimizes the blockage of the reflector aperture excited by the horn antenna 100 and tapers the electric field intensity in the E plane such that the E plane field is equalized to that in the H plane. In addition, the conductive ring 110 extends a finite distance beyond the mouth of the horn antenna 100. This extension 180 is important in that the fields, concentrated between the four ridges 130A, 130B, 130C, 130D, incident on the conductive ring 110 are maximized to enhance the radiation pattern of the horn antenna 100.

It should be mentioned, that the conductive ring 110 solves the difficult problem of exciting a reflector, or an array of reflectors, in two closely spaced bands, such as the Ku band. The ring depth 170 has been further optimized to function in the transmit band and the receive band of the Ku band. The Ku receive band is nominally 10.7 through 12.75 GHz, while the Ku transmit band is nominally 14.0 through 14.5 GHz.

The ridges 130A, 130B, 130C, 130D are illustrated in FIG. 4 as being tapered from the back of the horn antenna 100. However, the present invention does not require that the ridges be tapered. The ridges 130A, 130B, 130C, 130D each have finite width 190 at the mouth of the horn antenna 100, hereinafter the residual ridge 190. This residual ridge 190 ensures that the lowest frequency of operation propagates at the mouth of the horn antenna 100. The residual ridge 190 also provides a means for impedance matching and efficiently propagating the electric field into space.

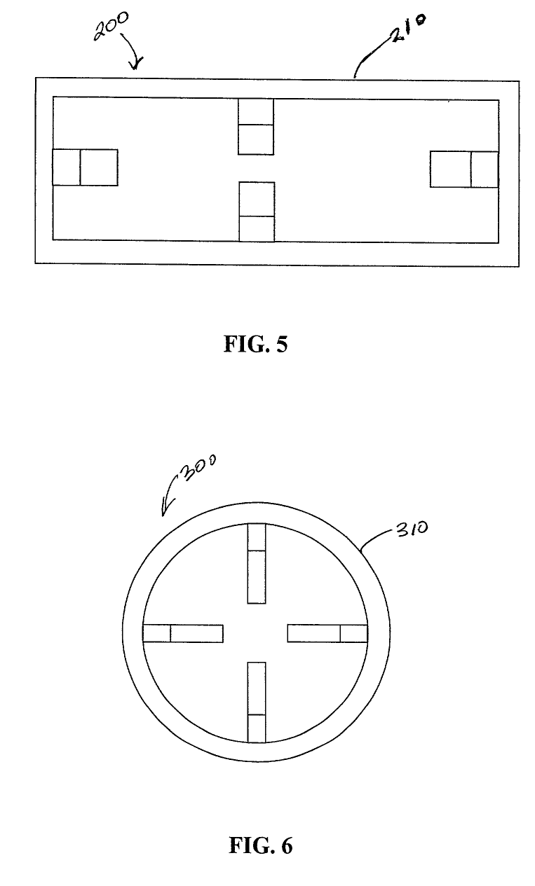

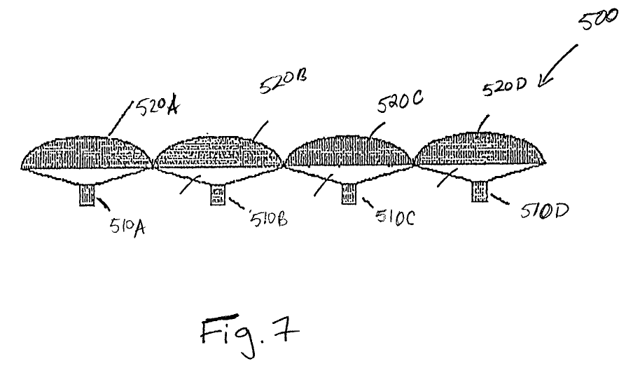

According to alternative embodiments, FIGS. 5 and 6 illustrate various cross-sections of the conductive ring. FIG. 5 illustrates a cross-sectional view of a quad-ridged horn antenna 200 having conductive ring 210 with a rectangular cross-section. In this particular embodiment, the quad-ridged horn antenna has 180 degree rotational symmetry. In contrast, FIG. 6 illustrates a cross-sectional view of a quad-ridged horn antenna 300 having a conductive ring 310 with a circular cross-section. The conductive ring 310 of FIG. 6 provides 90 degree rotational symmetry to the quad-ridged horn antenna 300.

FIG. 7 illustrates another alternative embodiment in which an antenna array 500 is comprised of a plurality of scalar ridged horn antennas 510A, 510B, 510C, 510D, of the present invention. Each of the four ridged horn antennas 510A, 510B, 510C, 510D are located at the focal point of a corresponding parabolic reflector 520A, 520B, 520C, 520D. The parabolic reflectors 520A, 520B, 520C, 520D are disposed contiguously in the antenna array 500.

What is claimed is:

1. A ridged horn antenna for transmitting and receiving signals in dual-bands and having equal E plane and H plane beamwidths, the ridged horn antenna including:
an excitation means;
a horn waveguide, being an electrically conductive conduit, and the horn waveguide having a first end and a second opposite end along a horn axis, the first end adjacent to the excitation means, and the horn waveguide forming a mouth at a second opposite end;
four ridges being spaced apart and extending longitudinally on an inner side of the horn waveguide relative to horn axis and each of the four ridges tapering to the mouth of the horn waveguide, the four ridges having a 180 degree rotational symmetry, and the four ridges being excited by the excitation means at a first end of the horn waveguide; and
a conductive ring around the mouth of the horn for terminating an aperture field formed between each of the four ridges, the conductive ring having a ring depth being optimized for simultaneous operation in a receive band and a transmit band of the dual-band;
wherein the E plane and H plane beamwidths are equalized.

2. A ridged horn antenna as defined in claim 1, wherein the dual-band is a Ku-band having a Ku receive band being nominally 10.0 through 12.75 GHz, and a Ku-transmit band being nominally 14.0 through 14.5 Ghz

3. A ridged horn antenna as defined in claim 1, wherein the conductive ring has a square cross-section orthogonal to the horn axis.

4. A ridged horn antenna as defined in claim 1, wherein the conductive ring has a rectangular cross-section orthogonal to the horn axis.

5. A ridged horn antenna as defined in claim 1, wherein the conductive ring has a circular cross-section orthogonal to the horn axis.

6. A ridged horn antenna as defined in claim 1, wherein the conductive ring has a depth of less than half of one free space wavelength in both operating bands.

7. A ridged horn antenna as defined in claim 1, wherein the conductive ring extends beyond the second opposite end of the horn waveguide along the horn axis.

8. A plurality of ridged horn antennas as defined in claim 1, wherein each ridged horn antenna is located at the focal point of a parabolic reflector, each parabolic reflector disposed contiguously in a array of parabolic reflectors.
